(19) United States
(12) Patent Application Publication
(10) Pub. No.: US 2025/0371311 A1
(43) Pub. Date: Dec. 4, 2025

(54) Recurrent Neural Network-Based Analog Cache System

(71) Applicant: Bank of America Corporation, Charlotte, NC (US)

(72) Inventors: Shailendra Singh, Maharashtra (IN); Saurabh Gupta, New Delhi (IN); Shreya Manocha, Gurugram (IN)

(73) Assignee: Bank of America Corporation, Charoltte, NC (US)

(21) Appl. No.: 18/733,116

(22) Filed: Jun. 4, 2024

(51) Int. Cl. G06N 3/0442; G06N 3/065

(52) U.S. Cl. CPC G06N 3/0442; G06N 3/065

(57) ABSTRACT

Various aspects of the disclosure relate to utilizing recurrent neural network (RNN) technologies to facilitate simulation of brain inspired data storage patterns in analog storage media via neuromorphic computing. An RNN-based analog cache system incorporates a self-adjusting mechanism that constantly evaluates the relevance and/or usage patterns of stored data. When data becomes obsolete and/or is less frequently accessed, the neural connections of the RNN-based analog cache system are dynamically readjusted to prioritize more relevant information, thus optimizing cache utilization. The RNN-based analog cache system captures one or more temporal relationships between different stored data elements to automatically learn and leverage temporal dependencies, to predict future data access patterns from users and/or applications accessing data stored within the RNN-based analog cache

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly manage how internal computer systems exchange information with external computer systems in providing and/or supporting different products and services offered by the organization.

In the contemporary digital landscape, the exponential growth of data poses a significant challenge to the efficiency of digital caching systems. As organizations accumulate vast amounts of data from various sources, the traditional digital cache mechanisms struggle to cope with the sheer volume and/or diversity of information. This inefficiency leads to suboptimal performance, increased latency, and a higher risk of cache misses, ultimately impacting the overall system responsiveness, system stability, and user experience.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes utilizing recurrent neural network (RNN) technologies to facilitate simulation of brain inspired data storage patterns in analog storage media via neuromorphic computing.

The present disclosure describes an intelligent solution that accommodates the massive scale of data processed for many modern applications and also leverages the intricacies of brain-inspired storage patterns through neuromorphic computing. For example, an RNN-based analog cache improves data storage and/or retrieval capabilities by mimicking neural patterns observed in the brain. This analog cache system may store data differently than present data caching mechanisms that utilize on defined storage locations. Rather, the RNN-based analog cache system rather may store data based on a timestamp associated with data creation, thus creating a dynamic and adaptive storage architecture capable of self-reorganization as data becomes obsolete.

The RNN-based analog cache system may include features such as neural pattern storage, chronological saving of data, dynamic adaptability, temporal context integration, and/or machine learning integration. For example, neural pattern storage by the RNN-based analog cache system may include adoption of a neural pattern storage mechanism that resembles the way the brain encodes and stores information. The RNN structure facilitates retention and maintenance of a memory of previous inputs in their internal state, storage, and handling of chronological data, and capture of data dependencies over time. Further, each node in the neural network may represent a unique data element. Connections between nodes may be established based on the chronological order of data creation, thus mirroring the brain's associative memory. One or more hidden layers of the RNN may be used to maintain data relevance, data relationship, and/or timestamp information.

As discussed above, chronological saving of data may, unlike traditional data caches that store data in fixed locations, allow the RNN-based analog cache system to organize data based on the timestamp of data element creation. As such, the RNN-based analog cache system may ensure that newer information is readily accessible, thus promoting efficient data retrieval and reducing latency associated with cache misses.

Dynamic adaptability of the RNN-based analog cache system is facilitated by incorporation of a self-adjusting mechanism that constantly evaluates the relevance and/or usage patterns of stored data. When data becomes obsolete and/or is less frequently accessed, the neural connections of the RNN-based analog cache system are dynamically readjusted to prioritize more relevant information, thus optimizing cache utilization.

By incorporating temporal context into the storage structure, the RNN-based analog cache system captures one or more temporal relationships between different pieces of data (e.g., different stored data elements). This enables the RNN-based analog cache system to automatically learn and leverage temporal dependencies, which enhances an ability to predict future data access patterns from users and/or applications accessing data stored within the RNN-based analog cache. Further, the RNN-based analog cache system integrates one or more machine learning (ML) algorithms to analyze information associated with stored data elements, such as access information, storage data information, relationships to other data objects, relationships between data access events, and/or the like. Additionally, the ML algorithms may allow the RNN-based analog cache system to predict evolving data access patterns based on the analyzed information. As the RNN-based analog cache system learns from usage trends, the RNN-based analog cache system autonomously adapts neural connections within the RNN, thus ensuring optimal storage and retrieval efficiency over time.

Aspects of the disclosure relate to computer hardware and software. In particular, one or more aspects of the disclosure generally relate to a neuromorphic computing-based recurrent neural network powered and self-adapting time series-enabled analog cache.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for providing a recurrent neural network-based analog cache system, in accordance with one or more aspects described herein;

FIG. 1B shows an illustrative computing platform enabled for management of the recurrent neural network-based analog cache system, in accordance with one or more aspects described herein;

FIG. 2 shows illustrative an illustrative representation of a recurrent neural network analog cache in accordance with one or more aspects described herein; and

FIG. 3 shows an illustrative block diagram representation of interacting components of the recurrent neural network analog cache system, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

One of the primary issues contributing to inefficiencies of present cache systems is the limited capacity of digital caches compared to the ever-expanding data sizes. As data sets continue to grow at an unprecedented rate, the mismatch between cache capacity and data volume becomes more pronounced, resulting in a higher likelihood of cache evictions and reduced hit rates. Consequently, these evictions and reduced hit rates undermines the purpose of caching, which is to accelerate data retrieval by storing frequently accessed information in a faster, more accessible location. Further, modern data set's heterogeneous nature, which includes diverse file formats, multimedia content, complex data structures, and/or the like, exacerbates challenges faced by digital cache systems. For example, due to large sizes of some of the stored information, cache data storage limits may be hit earlier, resulting in a cache that sores much less data than anticipated or necessary for efficient computing operations. Traditional caching algorithms may not effectively adapt to the varying access patterns and types of data, leading to suboptimal cache utilization and increased retrieval times. This issue is particularly prominent in scenarios where real-time processing and low-latency access to large datasets are crucial.

Another critical aspect contributing to inefficiency is the lack of dynamic adaptability in many existing digital cache architectures. As data characteristics and access patterns evolve over time, static caching strategies may become obsolete, resulting in inefficient use of cache resources. This inability to dynamically adjust to changing conditions limits the present cache systems ability to provide optimal performance in dynamic and unpredictable environments. For example, the present cache architecture is becoming increasingly complex due to an increasing number of cache levels and sizes along with different types of caches for different purposes. These issues add to the programming complexity to allow the processor to follow separate instruction for each cache, or even separate caches for different cores or threads. As such, the cache systems often lack coherence and fail to be optimized. Additionally, due to a lack of cache coherence protocols and mechanisms, the present cache systems may experience data corruption and/or inconsistency events. For example, delays in accessing the frequently used data and code, that may be due to lack of consistency of data across different cache levels and/or locations, leads to cache inefficiencies impacting all applications across an enterprise network relying on cache access.

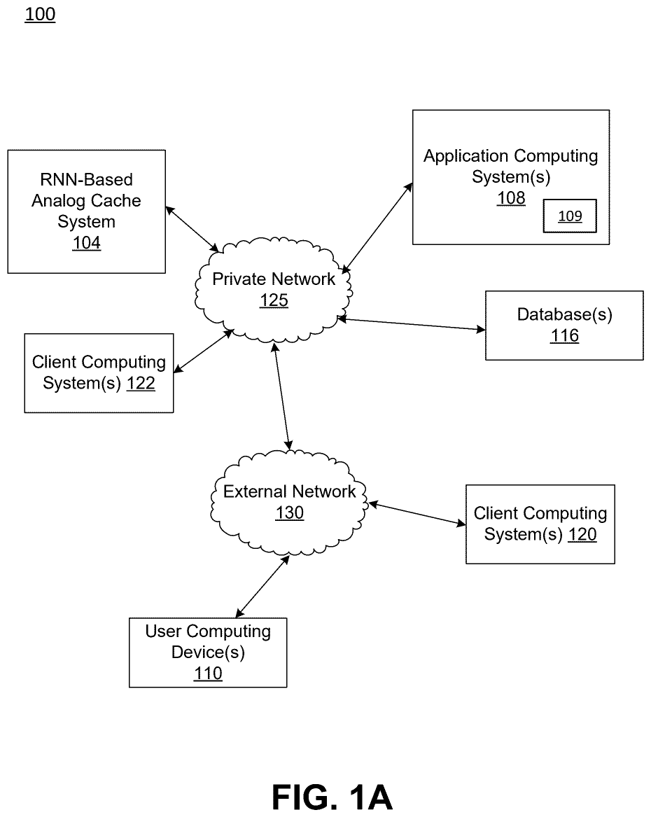

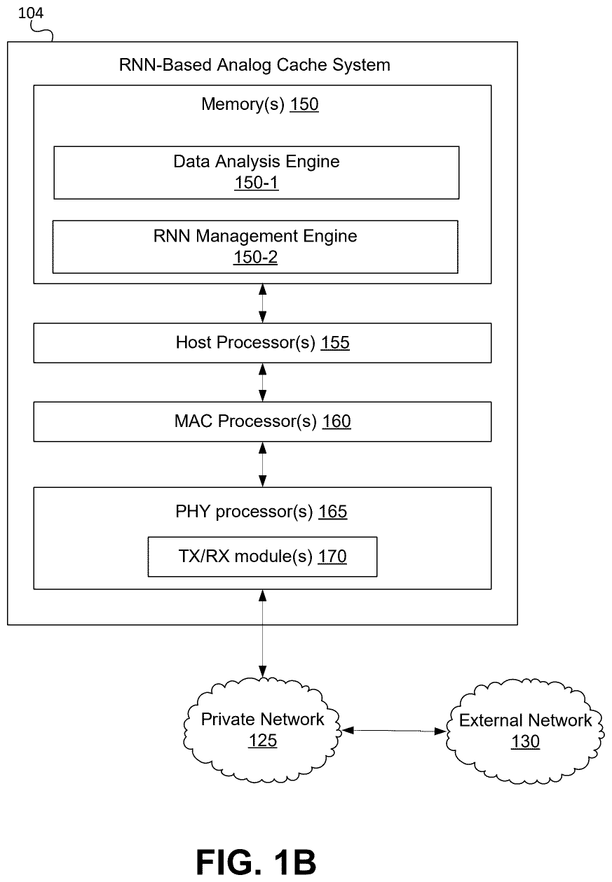

FIG. 1A shows an illustrative computing environment 100 for providing a recurrent neural network-based analog cache system, in accordance with one or more arrangements. The computing environment 100 may comprise one or more devices (e.g., computer systems, communication devices, and the like). The computing environment 100 may comprise, for example, a recurrent neural network (RNN)-based analog cache system 104, one or more application computing systems 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing systems 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the RNN-based analog cache system 104 as a stand-alone computing system, the RNN-based analog cache system 104 may be incorporated within one or more different computing systems, such as the application computing systems 108, the client computing systems 120, and/or the like.

The RNN-based analog cache system 104 may comprise one or more computing devices and/or other computer components (e.g., processors, memories, communication interfaces) configured to perform one or more functions as described herein. Further details associated with the architecture of the RNN-based analog cache system 104 are described with reference to FIG. 1B.

The application computing systems 108 and/or the client computing systems 122 may comprise one or more computing devices and/or other computer components (e.g., processors, memories, communication interfaces). In addition, the application computing systems 108 and/or the client computing systems 122 may be configured to host, execute, and/or otherwise provide one or more enterprise applications. In some cases, the application computing systems 108 may host one or more services 109 configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services 109. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing systems 122 and/or the application computing systems 108 may comprise various servers and/or databases that store and/or otherwise maintain account information, such as financial account information including account balances, transaction history, account owner information, and/or other information. In addition, the client computing systems 122 and/or the application computing systems 108 may process and/or otherwise execute transactions on specific accounts based on commands and/or other information received from other computer systems comprising the computing environment 100. In some cases, one or more of the client computing systems 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights. To perform one or more of the illustrative operations, the application computing systems 108 and/or similarly the client computing systems 120 and the client computing systems 122 may utilize caches, such as the RNN-based cache system 104 to quickly access relevant data and/or instructions to provide efficiently processed results to a requesting computing device.

The client computing systems 120 may comprise one or more computing devices and/or other computer components (e.g., processors, memories, communication interfaces). The client computing systems 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 120 is for processing an electronic exchange of goods and/or services. The client computing systems 120 may be associated with a specific goods purchasing activity, such as purchasing a vehicle, transferring title of real estate may perform communicate with one or more other platforms within the client computing systems 120. In some cases, the client computing systems 120 may integrate API calls to request data, initiate functionality, or otherwise communicate with the one or more application computing systems 108, such as via the services 109. For example, the services 109 may be configured to facilitate data communications (e.g., data gathering functions, data writing functions, and the like) between the client computing systems 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by RNN-based analog cache system 104 and/or the application computing systems 108. For example, the database(s) 116 may store RNN patterns, RNN analysis algorithms, data analysis algorithms, data analysis models, and/or the like. In an arrangement, the database(s) 116 may be used for other purposes as described herein. In some cases, the client computing systems 120 may write data or read data to the database(s) 116 via the services 109.

In one or more arrangements, the RNN-based analog cache system 104, the application computing systems 108, the client computing systems 122, the client computing systems 120, the user devices 110, and/or the other devices/systems in the computing environment 100 may be any type of computing device capable of receiving input via a user interface, and communicating the received input to one or more other computing devices in the computing environment 100. For example, the RNN-based analog cache system 104, the application computing systems 108, the client computing systems 122, the client computing systems 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the RNN-based analog cache system 104, the application computing systems 108, the client computing systems 122, the client computing systems 120, the user devices 110, and/or the other devices/systems in the computing environment 100 may, in some instances, be and/or comprise special-purpose computing devices configured to perform specific functions.

FIG. 1B shows an illustrative RNN-based analog cache system 104 in accordance with one or more examples described herein. The RNN-based analog cache system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The RNN-based analog cache system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the RNN-based analog cache system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the RNN-based analog cache system 104 may be configured to execute machine readable instructions stored in memory 150. The memory 150 may comprise (i) one or more program modules/engines having instructions that when executed by the one or more processors cause the RNN-based analog cache system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the RNN-based analog cache system 104 and/or by different computing devices that may form and/or otherwise make up the RNN-based analog cache system 104. For example, the memory 150 may have, store, and/or comprise a data analysis engine 150-1, a RNN management engine 150-2, and/or the like. The data analysis engine 150-1 may have instructions that direct and/or cause the RNN-based analog cache system 104 to perform one or more operations associated with analyzing data chronology information, calculating a data relevance score, and/or the like. The RNN management engine 150-2 may have instructions that may cause the RNN-based analog cache system 104 to perform manage the RNN-based analog cache 104 by performing neuromorphic data analysis, building an RNN pattern, analyzing feedback from systems utilizing the data stored in the RNN-based analog cache 104, and intelligently rebuilding the RNN analog cache based on the analysis information and/or the data analysis information from the data analysis engine 150-1.

While FIG. 1A illustrates the RNN-based analog cache system 104 and/or the application computing systems 108, as being separate elements connected in the private network 125, in one or more other arrangements, functions of one or more of the above may be integrated in a single device/network of devices. For example, elements in RNN-based analog cache system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

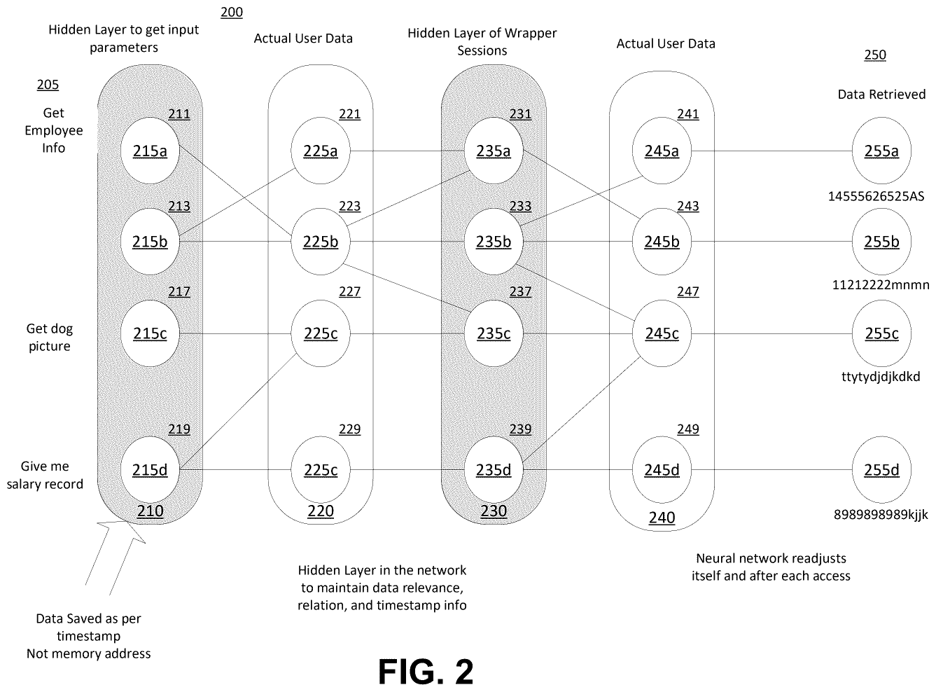

FIG. 2 shows illustrative an illustrative representation of a recurrent neural network analog cache 200 in accordance with one or more aspects described herein. A recurrent neural network (RNN) may have multiple layers, including one or more hidden layers 210 and 230 and one or more data layers 220 and 240. Links between the layers are represented as lines in FIG. 2. Here input data (e.g., input parameters 205) may be input into the RNN via a first hidden layer 210, where each node in the RNN (e.g., nodes 215a-d, nodes 225a-d, nodes 235a-d, nodes 245a-d, and the like) may be associated with a timestamp of saved data. As discussed above, the RNN analog cache 200 may store or otherwise manage saved data via a timestamp rather than a memory address. In the illustrative example, the input parameter “get employee info” may be stored in the node 215a associated with time 211, a data request may be stored in node 213b associated with time 213, the input parameter “get dog picture” may be stored in node 215c associated with time 217, and input parameter “give me salary record” may be stored in node 215d associated with time 219. The RNN may associate the input parameters in the hidden layer 210 with actual data associated with the data layer 220, where the hidden layers in the network maintain data relevance, relationships, and timestamp information. For example, the input parameter of node 215a may be related to or otherwise relevant to data of node 225b and associated with time 223. Similarly, the input parameter of node 215b may be related to or otherwise relevant to data of node 225a and associated with time 221 and the data of node 225b and associated with time 223, the input parameter associated with node 215c may be related to or otherwise relevant to data of node 225c and associated with time 227, and the input parameter of node 215d may be related to or otherwise relevant to data of node 225c and associated with time 227 and related to or otherwise relevant to data of node 225d and associated with time 229.

The hidden layer of wrapper sessions maintains data relevance, relationship information, and/or timestamp information between data layers. For example, node 235a and associated with timestamp 231 may identify that a time “5” (e.g., node 225a) may have relevance score 1 to time “1” (e . . . , node 215a) and may be related to time “9” (e.g., a node 245b). node. Node 235b, associated with time 233, may identify that time 6 (e.g., node 225b) may have relevance score 99 to time “10” (e . . . , node 245a) and may be related to time 10 (e.g., a node 245b). Node 235c (e.g., time 7), associated with time 237, may have a relevance score 5 to time “11” (e.g., node 245c). Additionally, node 235d “time 8”, associated with time 239, may have a relevance score of 22 related to time 12 (e.g., node 245d). A second data layer 240 (e.g., nodes 245a associated with time 241, 245b associated with time 243, 245c associated with time 247, and node 245d associated with time 249, and the like) may be associated with the data having the highest relevance scores to recent data queries entered via the input layer. Output 250 (e.g., nodes 255a-d) from the RNN analog cache 200 may be associated with the data having the highest relevance scores of all connected nodes based on the input 205. If a single linked node is connected via the hidden layer 230, then that data will be output. Otherwise, when multiple nodes are linked via the hidden layer 230, then the output 250 may be the node having the greatest relevance score to the input. The relevance scores may be dynamically created and may be, for example, a weighted combination of connections based on same or similar input data. Over time, the RNN analog cache system may dynamically, and automatically, self-adjust (e.g., readjust) after each data access request.

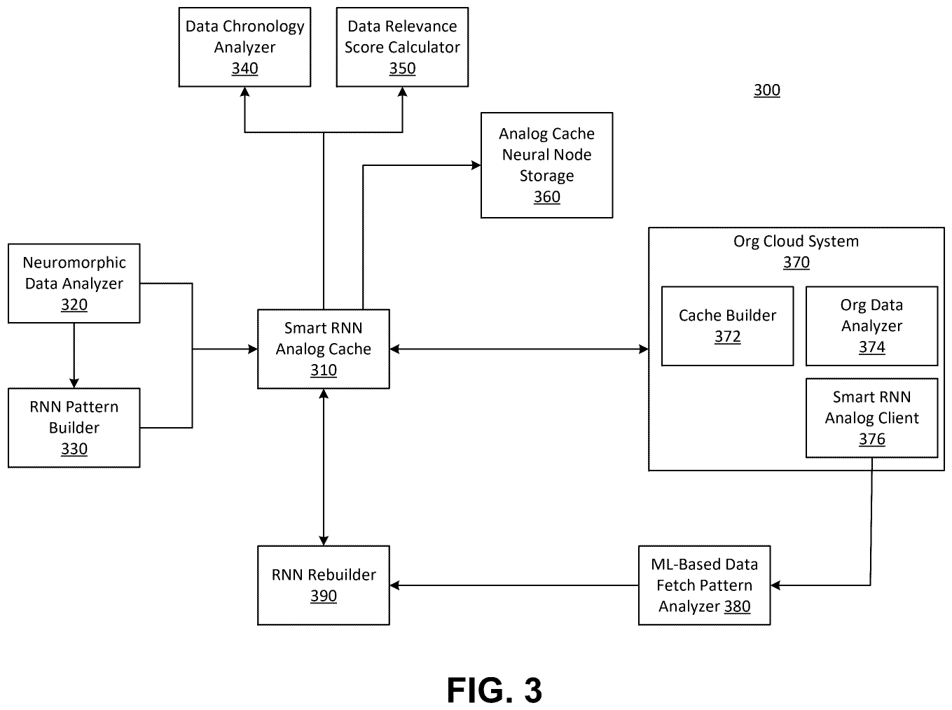

FIG. 3 shows an illustrative block diagram representation of interacting components of the recurrent neural network analog cache system 300, in accordance with one or more aspects described herein. A smart RNN analog cache 310 may be communicatively coupled to a neuromorphic data analyzer 320 and/or an RNN pattern builder to automatically adjust data connections based on neuromorphic data analysis of stored data and/or to identify data access patterns. As part of the neuromorphic data analysis, the neuromorphic data analyzer 320 may process one or more neuromorphic algorithms to improve energy efficiency, execution speed, robustness against local failures and the ability to learn. In an illustrative example, the smart RNN analog cache system 300 may include surrogate gradient learning that may self-correct learning for mismatch conditions. The RNN analog cache system 300 may utilize a data chronology analyze to manage time based changes of data stored in the analog cache where, in combination with the data relevance score calculator 350, may calculate data relevance scores based on data storage chronology, data access chronology, and/or a number of access requests and/or cross-references to one or more input queries and/or input parameters. For example, recent data may contribute to a data relevance calculation more than older data. In some cases, a number of data connections may improve the data relevance score such as a number of hits with respect to different queries and/or input parameters.

The smart RNN analog cache 310 may be coupled to an analog cache neural node storage system, such as an analog computing system. The Smart RNN analog cache 310 may be communicatively coupled to one or more external computing systems utilizing the smart RNN analog cache 100 to facilitate computing operations, such as a cloud computing system 370. The cloud computing system 3370 may include a cache builder 372 that may facilitate building of the analog cache customized for the external computing system. An organization data analyzer 374 may analyze data stored and/or received from the smart RNN analog cache 310 to ensure proper operation and data use and/or data return. Additionally, to link the smart RNN analog cache 310 to the cloud processors, a smart RN analog client 376 may facilitate communication between the cloud computing processing systems and the smart RNN analog cache 310. A machine learning (ML)-based fetch pattern analyzer 380 may analyze and/or identify data access patterns (e.g., fetching patterns) to determine feedback of the data relevance and/or data chronology to ensure efficient operation of the smart RNN analog cache 310. Output of the ML-based data fetch pattern analyzer may be used by an RNN rebuilder 390 to rebuild the RNN, such as after each data access, as discussed with respect to FIG. 2.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
an external computing system comprising a first processor;
a recurrent neural network (RNN) analog cache platform, comprising:
a processor; and
memory storing computer-readable instructions that, when executed by the processor, cause the RNN analog cache platform to:
receive, from the external computing system via a network, an input parameter;
identify, by a first hidden layer, at least one connection between the input parameter and a plurality of data nodes;
calculate a relevance score between each matched data node and the input parameter, wherein the relevance score comprises a representation of a likelihood that the matched data node comprises a response to the input parameter; and
return, based on relevance scores, data associated with a first matched data node.

2. The system of claim 1, wherein each of the plurality of data nodes comprises a data object associated with a timestamp.

3. The system of claim 2, wherein the at least one connection between the input parameter and a first data node of the plurality of data nodes corresponds to the timestamp.

4. The system of claim 2, wherein the instructions cause the RNN analog cache platform to manage data dependencies over time.

5. The system of claim 1, wherein the instructions cause the RNN analog cache platform to store data with respect to a chronological order of data creation.

6. The system of claim 1, wherein the instructions cause the RNN analog cache platform to evaluate relevance and usage patterns of stored data to dynamically readjust neural connections between data nodes.

7. The system of claim 6, wherein the neural connections are readjusted to prioritize information corresponding to received input parameters.

8. A method comprising:
receiving, from an external computing system via a network, a plurality of input parameters;
identifying, by a first hidden layer, at least one connection between at least one input parameter of the plurality of input parameters and a plurality of data nodes;
calculating a relevance score between each matched data node and the at least one input parameter, wherein the relevance score comprises a representation of a likelihood that the matched data node comprises a response to the at least one input parameter; and
returning, based on relevance scores, data associated with each matched data node.

9. The method of claim 8, wherein each of the plurality of data nodes comprises a data object associated with a timestamp.

10. The method of claim 9, wherein the at least one connection between the input parameter and a first data node of the plurality of data nodes corresponds to the timestamp.

11. The method of claim 9, further comprising automatically managing data dependencies over time.

12. The method of claim 8, further comprising storing data with respect to a chronological order of data creation.

13. The method of claim 8, further comprising evaluating relevance and usage patterns of stored data to dynamically readjust neural connections between data nodes.

14. The method of claim 13, wherein the neural connections are readjusted to prioritize information corresponding to received input parameters.

15. Non-transitory computer readable media storing instructions that, when executed by a processor, cause recurrent neural network (RNN) analog cache platform to:
receive, from an external computing system via a network, an input parameter;
identify, by a first hidden layer, at least one connection between the input parameter and a plurality of data nodes;
calculate a relevance score between each matched data node and the input parameter, wherein the relevance score comprises a representation of a likelihood that the matched data node comprises a response to the input parameter; and
return, to the external computing system and based on relevance scores, data associated with a first matched data node.

16. The non-transitory computer readable media of claim 15, wherein each of the plurality of data nodes comprises a data object associated with a timestamp.

17. The non-transitory computer readable media of claim 16, wherein the at least one connection between the input parameter and a first data node of the plurality of data nodes corresponds to the timestamp.

18. The non-transitory computer readable media of claim 16, wherein the instructions cause the RNN analog cache platform to manage data dependencies over time.

19. The non-transitory computer readable media of claim 15, wherein the instructions cause the RNN analog cache platform to store data with respect to a chronological order of data creation.

20. The non-transitory computer readable media of claim 15, wherein the instructions cause the RNN analog cache platform to evaluate relevance and usage patterns of stored data to dynamically readjust neural connections between data nodes.
